(19) United States
(12) Patent Application Publication
(10) Pub. No.: US 2022/0410769 A1
(43) Pub. Date: Dec. 29, 2022

(54) CHILD SAFETY SEAT

(71) Applicant: Gerd MITTER, Wien (AT)

(72) Inventor: Gerd MITTER, Vienna (AT)

(21) Appl. No.: 17/756,251

(22) PCT Filed: Nov. 20, 2020
(86) PCT No.: PCT/AT2020/060411

§ 371 Date: May 19, 2022

(30) Foreign Application Priority Data
Nov. 22, 2019 (AT) A 51009/2019

(51) Int. Cl. B60N 2/28; B60N 2/90

(52) U.S. Cl. CPC B60N 2/2872; B60N 2/914; B60N 2002/2818; B60N 2002/2896

(57) ABSTRACT

A child safety seat for fitting on a vehicle seat of a vehicle, having: a seat element, a backrest element, in particular with an upper backrest part and a lower backrest part, wherein the backrest element is pivotable between a use position and a transport position, two side elements which are connected to the longitudinal edges of the backrest element, wherein the side elements each have a viscoelastic foam plate and a substantially air-tight outer casing around the viscoelastic foam plate, wherein the viscoelastic foam plates are held on the backrest element with fastening elements, wherein the fastening elements penetrate the viscoelastic foam plates and the outer casings in such a manner that air suction openings for sucking up air into the viscoelastic foam plates are formed.

### TECHNICAL FIELD

The disclosure relates to a child safety seat for fitting on a vehicle seat of a vehicle, comprising:
a seat element,
a backrest element, preferably comprising an upper backrest part and a lower backrest part, wherein the backrest element is pivotable between a use position and a transport position,
two side elements which are connected to the longitudinal edges of the backrest element.

### BACKGROUND AND SUMMARY

Child safety seats have been proposed in the prior art, which can be transferred between a use position for conveying a child and a compact transport position for transporting the child safety seat. Such a child safety seat is described, for example, in WO 2018/018060 A1. In order to facilitate transport of the child safety seat compared with conventional hard-shell seats, this child safety seat has side elements with inflatable air chambers. As a result of using “drop-stitch” fabrics, the side elements are dimensionally stable and stiff in the inflated state despite low weight. When the air is released from the side elements, the child safety seat can be transported in a particularly compact form. These child safety seats have proved very successful in practice. However, a disadvantage is that the side elements must be inflated via an inlet valve before use in the vehicle. Thus, a pump must also be carried.

In view of this, the object of the present disclosure is to ameliorate or eliminate at least individual disadvantages of the prior art. The disclosure in particular has the aim of creating a light child safety seat which allows easier handling than the prior art.

This object is achieved by a child safety seat. Preferred embodiments are given in the prior art.

The disclosure is characterized in that the side elements each comprise a visco-elastic foam plate and a substantially air-tight outer casing around the visco-elastic foam plate, wherein the visco-elastic foam plates are held on the backrest element with fastening elements, wherein the fastening elements penetrate the visco-elastic foam plates and the outer casings in such a manner that air suction openings for sucking up air into the visco-elastic foam plates are formed.

Depending on the external loading of the side elements, air can flow in or out via the air suction openings. When the child safety seat is transferred into the transport position, the side elements are compressed, with the result that air is pressed outwards through the air suction openings. In the compressed transport position, the side elements occupy little space, whereby transport is facilitated. When transferring the side elements into the transport position, the air suction openings are therefore configured as air outlet openings. When the child safety seat is arranged in the use position, the external loading on the child safety seat is reduced or disappears. As a result, air flows via the air suction openings into the foam plates which thereby adopt their original shape. Accordingly, the foam plates exhibit a memory effect. Preferably the foam plates are only connected to the surroundings via the air suction openings so that apart from the air suction openings on the fastening elements, the foam plates are arranged in a substantially airtight manner inside the outer casings. As a result of the airtight outer casing, the ingress and egress of air is restricted to the suction openings adjacent to the fastening elements. In the event of a side impact, only a little air can thus escape from the side element in the short time interval when the body of the child, in particular its shoulder, penetrates into the side element. As a result, the desired stability is ensured in the event of a side impact.

For the purposes of this disclosure, the positional and directional information such as “top”, “bottom”, “horizontal”, “vertical” etc. relate to the intended usage position of the child safety seat for conveying the child in the vehicle.

In a preferred embodiment, the air suction openings extend on the outer sides of the fastening elements on which the outer casings are recessed. Preferably the edges of the outer casings run adjacent to the fastening elements or abut against the fastening elements at least in sections. Advantageously, small-area, for example, annular air suction openings are formed. As a result, when pivoting the backrest element into the use position, air can enter into the foam plates in order to impart the desired shape to the foam plates. At the same time, in the case of a hard impact against the side element, air can only be pressed out of the foam plate to a very small extent, with the result that the required impact protection is ensured.

Depending on the design, preferably less than ten fastening elements, preferably less than five fastening elements and a corresponding number of air suction openings are provided per side element. Further preferably at least two fastening elements, for example, precisely three, fastening elements and a corresponding number of air suction openings per side element are provided.

In a preferred embodiment the fastening elements extend up to the outer sides of the side elements. This design on the one hand has the advantage that the side elements are reliably held on the backrest element. Furthermore, the configuration of the air suction openings is made easier.

In order to improve the introduction of load into the child safety seat in the event of a side impact, the fastening elements carry impact plates on the outer sides of the side elements. The impact plates are adapted to divert lateral forces in the event of a side impact from outside via the fastening elements into the backrest element. It has been shown that the diversion of force in the event of a side impact thus begins earlier and a more favourable load profile is achieved.

In order to improve the hold of the side elements on the backrest element and obtain smooth outer surfaces, the impact plates are arranged in countersinks on the outer sides of the side elements. Preferably the impact plates bring about a local compression of the foam plate, with the result that the countersinks are formed.

In a preferred embodiment the fastening elements are substantially cylindrical.

Preferably annular air suction or air outlet openings are formed on the outer circumference of the fastening elements.

Preferably the fastening elements extend substantially perpendicularly to the principal planes of the side elements. As a result, a favourable transmission of load into the structure is achieved.

For weight reasons it is advantageous if the fastening elements are configured as sleeves, i.e. with cavities.

In a preferred embodiment, the backrest element comprises an upper backrest part and a lower backrest part, which are pivotable with respect to one another between a use position and a transport position. For transporting the child safety seat outside the vehicle the backrest element is therefore folded up in the transport position. For fastening to the vehicle seat the backrest element is unfolded into the use position. In this design the fastening elements are preferably arranged on the longitudinal edges of the upper backrest part. The fastening elements may be screwed to the longitudinal edges of the backrest element.

In order on the one hand to increase the hold of the side elements on the backrest element and on the other hand to improve the load transmission in the event of a side impact, the side elements are preferably held on the backrest element via at least two fastening elements, wherein the two fastening elements are spaced apart from one another in the direction of the respective longitudinal edge of the backrest element. Particularly preferably precisely three fastening elements per side element are provided. In this embodiment preferably at least one fastening element, more preferably two fastening elements are provided in the upper region of the upper backrest part and at least one fastening element is provided in the lower region of the upper backrest part.

In a preferred embodiment, sealing elements, in particular sealing rings, are arranged on the fastening elements. Thus, the edges of the outer casings can be pressed around the air suction openings against the sealing elements. As a result, the escape of air from the side element can be reduced to a minimum when the side element is compressed as a result of a sudden loading, in particular in the event of a side impact. On the other hand, a slow ingress of air into the side elements is released through the sealing elements during transfer into the use position in the unloaded state. The sealing elements thus act as a non-return valve.

### BRIEF DESCRIPTION OF THE FIGURES

In use the child safety seat is mounted detachably on a vehicle seat of a motor vehicle.

The disclosure will be explained further hereinafter with reference to an exemplary embodiment shown in the figures.

FIG. 1A shows a child safety seat according to the disclosure in which an integrated five-point belt is provided.

FIG. 1B shows the child safety seat according to the disclosure wherein, however, a vehicle's three-point belt is used which is guided via an adapter on the belt lock.

FIG. 1C shows the child safety seat according to the disclosure in a folded-up transport position.

FIG. 2 shows an adapter for detachable connection to a belt lock of the child safety seat in order to guide the belt of a vehicle's own safety belt in the region between the legs of the child.

FIG. 3A shows a front view of the adapter of FIG. 1B and FIG. 2.

FIG. 3B shows a variant of the adapter in which two guide elements are provided for the selective guidance of the safety belt on the front or on the rear side of the belt lock.

FIG. 4 shows a section along the line IV-IV in FIG. 3.

FIG. 5 shows a view corresponding to FIG. 4 but in the unlocked state of the adapter.

FIG. 6 shows schematically the guidance of a belt strap of the vehicle's own safety belt in the guide gap between the adapter and the belt lock.

FIG. 7 shows the child safety seat according to FIG. 1, wherein the detail A is emphasized.

FIG. 8 shows the detail A of FIG. 7 in enlarged view.

FIG. 9 shows a section along the line IX-IX in FIG. 8.

FIG. 10 and FIG. 11 show a sectional view according to FIG. 9 during folding up into the transport position.

FIG. 12 shows a side view of the child safety seat.

FIG. 13 shows a section along the line XII-XII in FIG. 12.

### DETAILED DESCRIPTION

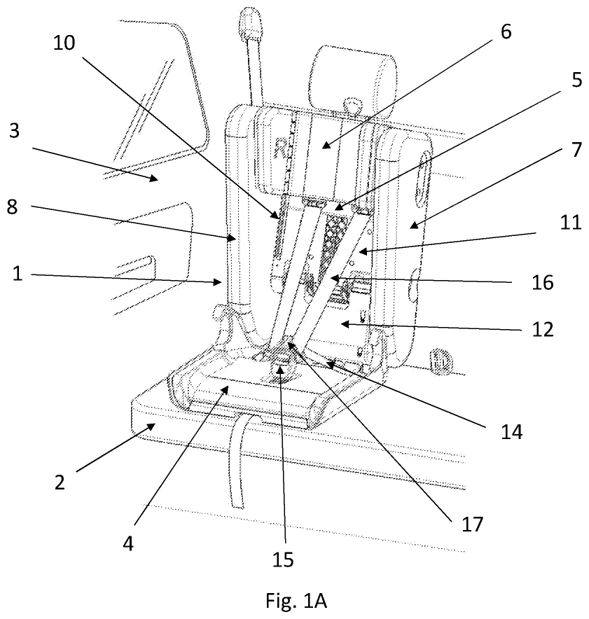

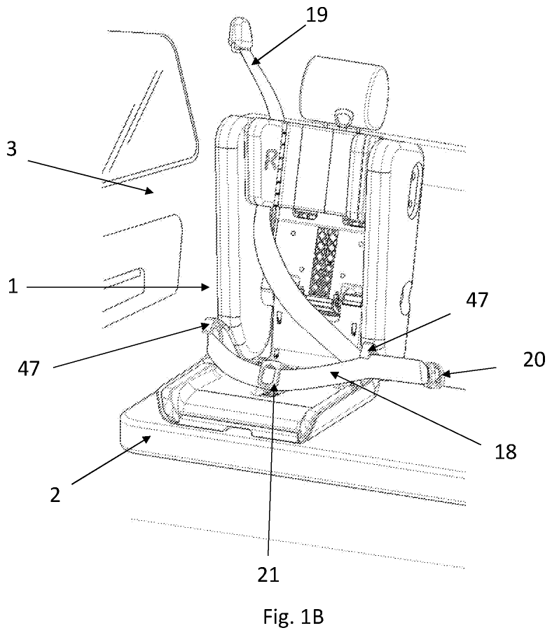

FIG. 1A and FIG. 1B each show a child safety seat 1 for a child (not shown). The child safety seat 1 is provided for fastening to a (schematically depicted) vehicle seat 2 of a vehicle 3, in particular a passenger vehicle. For this purpose the child safety seat 1 has fastening means, possibly locking means, for a corresponding holding on the vehicle seat. These fastening means are sufficiently known in the prior art.

The child safety seat 1 comprises a seat element 4 which supports the buttocks of the child when the child safety seat 1 is used as intended. In addition, the child safety seat 1 has a backrest element 5 by means of which, when the child safety seat 1 is used as intended, the back and the head of the child is supported. In the region of the child's head, a head part 6 is additionally provided on the front side of the backrest element 5. An upholstery can be provided on the backrest element 5 and the seat element 4. The backrest element 5 and the seat element 4 enclose a seat opening angle which is preferably greater than 90°. The seat element 4 and the backrest element 5 are formed of a dimensionally stable material. Preferably the seat element 4 and the backrest element 5 are substantially fabricated from a hard plastic material, in particular from polyamide or polypropylene.

The child safety seat 1 has at the sides (in relation to the direction of travel of the vehicle) a first side element 7 and a second side element 8 (hereinafter for short “side elements”). The first side element 6 is connected to the first longitudinal edge 9 of the backrest element 5. The second side element 7 is in each case connected to a second longitudinal edge 10 of the backrest element 5. The first 9 and second longitudinal edge 10 of the backrest element 5 extend laterally on the backrest element 5 and are connected to one another via an upper transverse edge and a lower transverse edge of the backrest element 5.

As can be seen from FIGS. 1A, 1B and 1C the backrest element 5 has an upper backrest part 11 and a lower backrest part 12 which form a substantially flat backrest in the use position. The upper backrest part 11 is connected to the lower backrest part 12 via an articulated connection 13 in order to fold up the backrest element into a transport position shown in FIG. 1C. The articulated connection 13 of the backrest element 5 is explained in further detail below.

As can be seen from a comparison of FIG. 1A and FIG. 1B, the child safety seat 1 is adapted for two different uses. For smaller children aged from 1 to 4 years, the child safety seat 1 has a child safety seat belt 14, here a five-point belt, with a child safety seat belt lock 15 (hereinafter for short “belt lock”) and two shoulder and side straps 16 on which locking tongues 17 are provided for locking with the belt lock 15 (cf. FIG. 1A). The child safety seat belt 14 is independent of the vehicle 2 and therefore integrated in the child safety seat 1. For older children aged from 3 to 12 years, a vehicle belt 18, in particular a three-point safety belt, can be used which comprises a belt strap 19 and a vehicle belt lock 20 provided on the vehicle 3. Preferably both the child safety seat belt 14 and also the vehicle belt 18 are provided on the child safety seat.

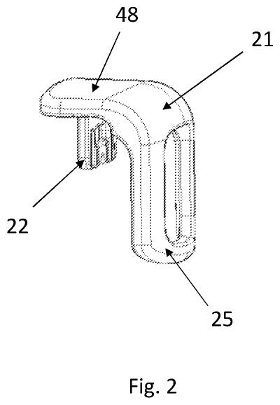

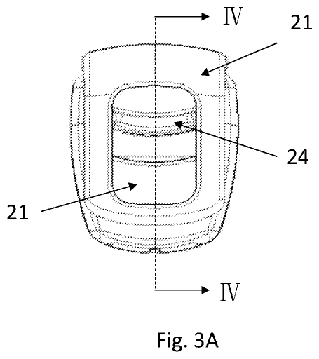

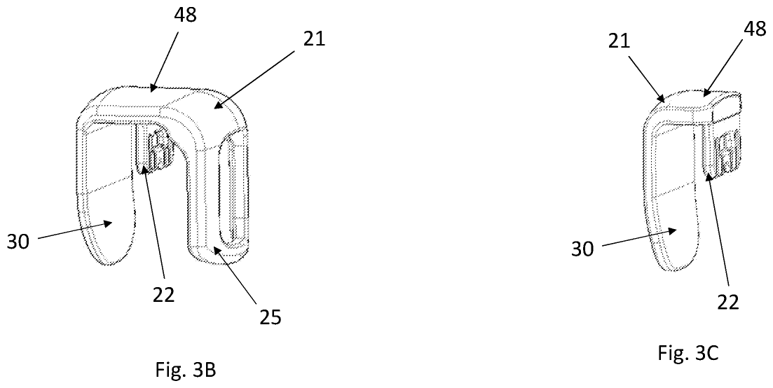

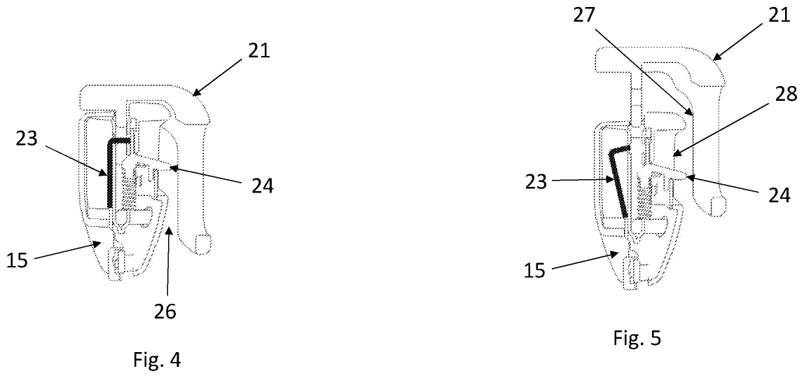

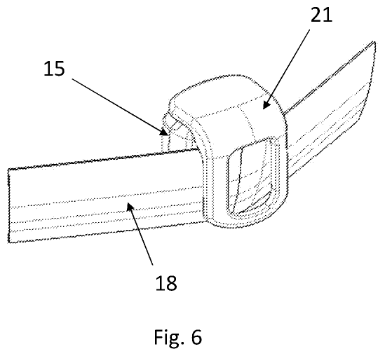

In order to improve the safety when using the vehicle belt 18 (cf. FIG. 1B), the child safety seat 1 has a belt lock adapter element 21 (hereinafter “adapter” for short) which can be locked with the belt lock 15 in a reversibly detachable manner (i.e. can be released repeatedly without losses of function). For this purpose the adapter 21 has a locking element 22 with a bolt receptacle in the form of a through opening in which a bolt 23 of the belt lock 15 engages in the locked state. The connection of the adapter 21 to the belt lock 15 can be seen most clearly from FIG. 4 (locked state) and FIG. 5 (unlocked state). In the unlocked state the bolt 23 of the belt lock 15 is located in a withdrawn rest position. The locking element 22 is placed from above into the belt lock 15. As a result, the lock mechanism is released which transfers the bolt 23 from the rest position into the engagement position in which the bolt 23 engages in the bolt receptacle of the locking element 22. The belt lock 15 additionally has on the front side (i.e. on the side facing the operator and facing away from the backrest element 4) a release element 24 by means of which the engagement of the bolt 23 in the bolt receptacle of the adapter 21 can be released in order to release the adapter 21 from the belt lock 15. The structure of the child safety seat belt 14 is known in the prior art. Various lock mechanisms can be provided with which the adapter 21 can interact.

The adapter 21 additionally has a guide element 25 for guiding the belt strap 19 of the vehicle belt 18. The guide element 25 is arranged on the front side of the belt lock 5, i.e. on the side facing the operator. A guide gap 26 for the belt strap 19 of the vehicle belt 18 is formed between the belt lock 15 and the guide element 25. The guide gap 26 between the belt lock 15 and the guide element 25 is open towards the bottom but closed towards the top (relative to the use position of the child safety seat 1) so that the belt strap 19 can be introduced from below into the adapter 21 and secured against slipping out upwards. The guide element 25 has a concavely curved inner side 27 which approximately follows the course of a convexly curved outer side 28 so that the guide gap 26 has a substantially constant width.

In the embodiment shown the guide element 25 has a recess 29 adjacent to the release element 24 of the belt lock 15 which allows access to the release element 24. Thus, the user can reach the release element 24 through the recess 29 in order to release the locking of the adapter 21.

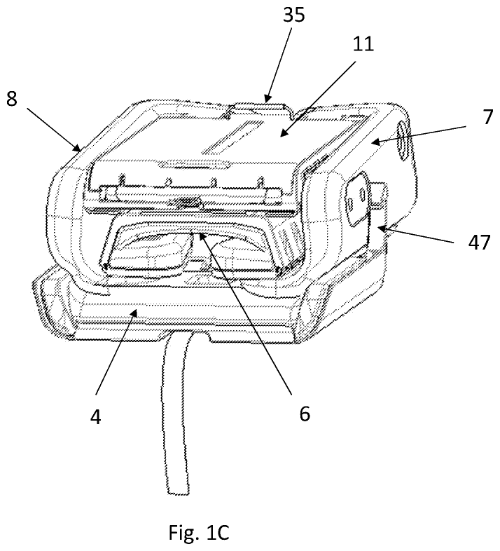

In the embodiment of FIG. 3B the adapter 21 has a further guide element 30 on the rear side of the belt lock 15. Unlike the guide element 25 the further guide element 30 is extensive, i.e. free from recesses because no actuation of the belt lock takes place in this region.

In the embodiment shown the locking element 22 and the guide element 25 are connected to one another via a retaining section 48 which in the locked state extends above the belt lock 15.

In the embodiment shown the child safety seat 1 additionally has lateral guide indentations 47 which are adapted for lateral guidance of the belt strap 19 of the vehicle belt 18.

As mentioned, the child safety seat 1 in the embodiment shown has a two-part backrest element 4 wherein the upper backrest part 11 is pivotable with respect to the lower backrest part 12 between a use position (cf. FIG. 1A, 1B) and a folded-up transport position (cf. FIG. 1C). The pivot angle between the use and the transport position is at least 100 degrees, preferably substantially 105 degrees. In order to block the upper backrest part 12 in the use position with respect to the lower backrest part 11, a reversibly detachable locking device 31 is provided.

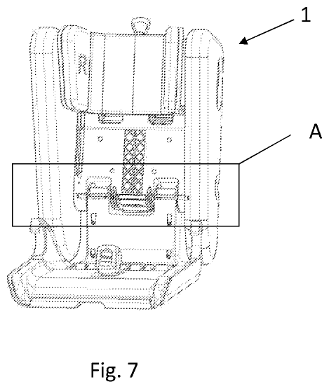

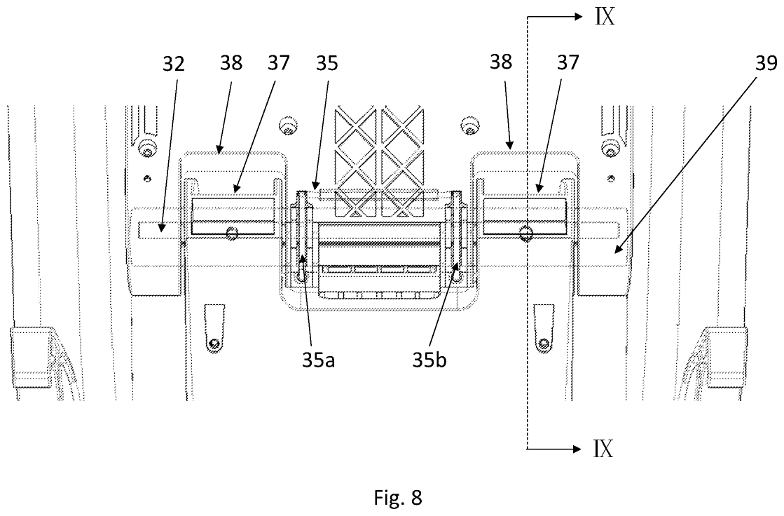

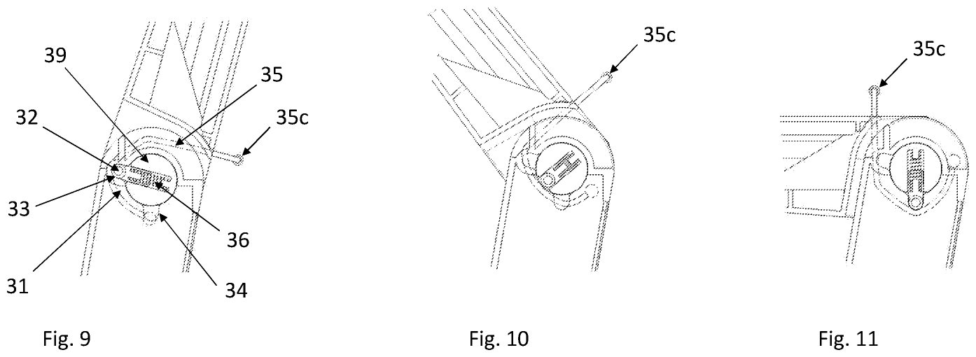

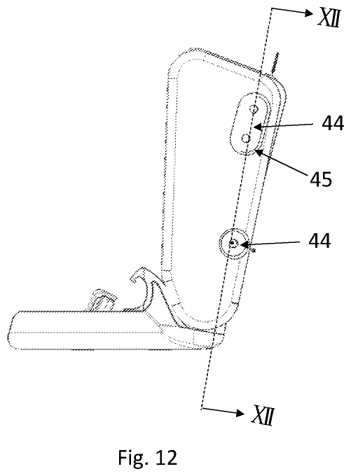

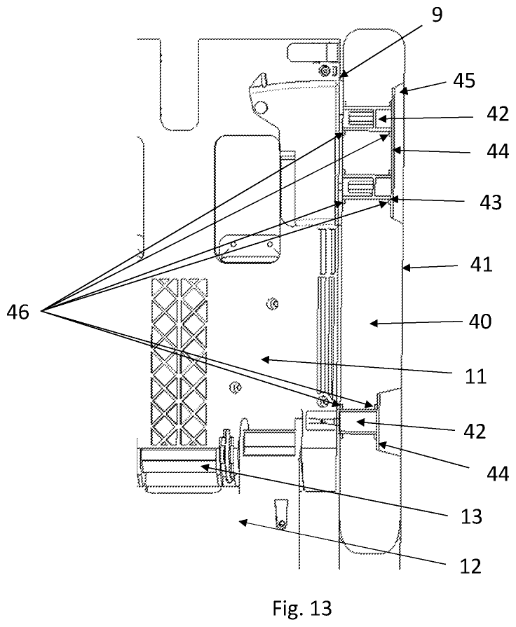

The locking device 31 comprises a locking rod 32, a first locking opening 33 and a second locking opening 34. In the use position the locking rod 32 is locked with the first locking opening 33 (cf. FIG. 9). In the transport position the locking rod 32 is locked with the second locking opening 34. The locking rod 32 extends in the transverse direction of the upper backrest part 12 substantially over the entire width of the upper backrest part 12. In the embodiment shown the locking rod 32 has a round, in particular circular cross-section. The locking device 31 additionally has an actuating element 35 by means of which the locking rod 32 can be released from the first locking opening 33 starting from the use position and from the second locking opening 34 starting from the transport position, i.e. brought out of engagement. Provided as actuating element 35 in the embodiment shown is a flexible rope with two actuating sections 35a, 35b which are wrapped around the outer side of the locking rod 32 spaced apart from one another in the transverse direction of the backrest element 4. On the rear side of the backrest element 4 the actuating element 35 has a grip section 35c to which the user can apply a tensile force in order to release the engagement of the locking rod 32 with the first locking opening 33 (or with the second locking opening 34). The locking device 31 additionally has a spring 36 which presses the locking rod 32 in the use position into the first locking opening 33 and in the transport position, into the second locking opening 34.

In the embodiment shown the lower backrest part 11 has two projections 37 which are arranged in corresponding recesses 38 of the upper backrest part 12. A joint axis 39 connects the projections 37 of the lower backrest part 11 to the adjacent sections of the upper backrest part 12. The locking rod 12 is mounted displaceably on the joint axis 39 against the force of the spring 36 in the radial direction.

In the embodiment shown, the side elements 7, 8 each comprise a visco-elastic foam plate 40 which is arranged in each case inside a substantially airtight outer casing 41. As a result, when unfolding the child safety seat 1 into the use position, air is sucked in in order to produce the original form of the side elements 7, 8. Furthermore, in the event of a side impact, only a very little air can escape from the side elements 7, 8 within a very short time interval, for example, a few milliseconds, with the result that a high impact protection is achieved. The visco-elastic foam material can, for example, comprise polyester and/or polyether. The outer casing 41 is preferably a fabric, in particular made of polyester, which is provided with a substantially airtight coating, in particular of TPU (thermoplastic polyurethane) or PVC (polyvinyl chloride). The visco-elastic foam plates 40 are fastened to the backrest element 5 by means of fastening elements 42. The fastening elements 42 project both through the visco-elastic foam plates 40 and also through the outer casings 41, wherein air suction openings 43 for sucking in air from the surroundings of the child safety seat 1 into the visco-elastic foam plates 40 are formed on the outer side of the fastening elements 42. The air flows in laterally at the fastening elements 42 and the outer casing 41, wherein the outer casing 41 behaves as a non-return valve at the edges adjacent to the fastening elements 42. If the shoulder of the child penetrates into one of the side elements 7, 8 in the event of an accident, only a little air can flow outwards.

The fastening elements 42 extend as far as the outer sides (facing away from the backrest element 5) of the side elements 7, 8. In the embodiment shown substantially cylindrical sleeves are provided as fastening elements 42 which extend substantially perpendicularly to the principal planes of the side elements 7, 8 (i.e. substantially in the horizontal direction).

In the embodiment shown impact plates 44 are arranged on the fastening elements 42 on the outer sides of the side elements 7, 8. The impact plates 44 are here arranged in countersinks 45 of the foam plates 40. The impact plates 44 are formed from a dimensionally stable material, in particular metal, a plastic, for example, from a fibre-reinforced plastic. The foam is compressed in the region of the impact plates 44.

In the embodiment shown the fastening elements 42 are fastened to the longitudinal edges 9, 10 of the upper backrest part 11, in particular by means of a screw connection. At least two, in the embodiment shown, three fastening elements 42 are arranged on each longitudinal edge 9, 10 by means of which the respective foam plate 40 is held on the backrest element 5. The fastening elements 42 are spaced apart from one another in the direction of the respective longitudinal edge 9, 10 of the backrest element 5. In the embodiment shown two upper fastening elements 42 are provided which carry a common impact plate 44. Furthermore a lower fastening element 42 is provided at the lower end region of the upper backrest part 11.

In the embodiment shown sealing elements 46, here in the form of sealing rings, are further provided on the fastening elements 42. As soon as the shoulder of a child 1 penetrates into the side element 7, 8 in the event of a side impact, the edges of the outer casing 1 are pressed against the sealing elements 46 with the result that the dimensional stability of the side element 7, 8 is ensured in the event of a side impact.

1. A child safety seat for fitting on a vehicle seat of a vehicle, comprising:
a seat element,
a backrest element, wherein the backrest element is pivotable between a use position and a transport position,
two side elements which are connected to the longitudinal edges of the backrest element,
wherein the side elements each comprise a visco-elastic foam plate and a substantially air-tight outer casing around the visco-elastic foam plate,
wherein the visco-elastic foam plates are held on the backrest element with fastening elements,
wherein the fastening elements penetrate the visco-elastic foam plates and the outer casings in such a manner that air suction openings for sucking up air into the visco-elastic foam plates are formed.

2. The child safety seat according to claim 1, wherein the fastening elements extend up to the outer sides of the side elements.

3. The child safety seat according to claim 1, wherein the fastening elements carry impact plates on the outer sides of the side elements.

4. The child safety seat according to claim 3, wherein the impact plates are arranged in countersinks on the outer sides of the side elements.

5. The child safety seat according to claim 1, wherein the fastening elements are substantially cylindrical.

6. The child safety seat according to claim 1, wherein the fastening elements extend substantially perpendicularly to the principal planes of the side elements.

7. The child safety seat according to claim 1, wherein the backrest element comprises an upper backrest part and a lower backrest part, which are pivotable with respect to one another between a use position and a transport position, wherein the fastening elements are arranged on the longitudinal edges of the upper backrest part.

8. The child safety seat according to claim 1, wherein the side elements are each held on the backrest element via at least two fastening elements, wherein the two fastening elements are spaced apart from one another in the direction of the respective longitudinal edge of the backrest element.

9. The child safety seat according to claim 1, wherein the sealing elements are arranged on the fastening elements.

10. A motor vehicle having a child safety seat according to claim 1.

11. The child safety seat according to claim 1, wherein the backrest element comprises an upper backrest part and a lower backrest part.

12. The child safety seat according to claim 9, wherein the sealing elements are sealing rings.
